(19) United States
(12) Patent Application Publication
(10) Pub. No.: US 2023/0291010 A1
(43) Pub. Date: Sep. 14, 2023

(54) SOLID ELECTROLYTE, BATTERY, AND SOLID ELECTROLYTE MANUFACTURING METHOD

(71) Applicant: Panasonic Intellectual Property Management Co., Ltd., Osaka (JP)

(72) Inventor: Honami SAKO, Osaka (JP)

(21) Appl. No.: 18/315,228

(22) Filed: May 10, 2023

Related U.S. Application Data
(63) Continuation of application No. PCT/JP2021/035204, filed on Sep. 24, 2021.

(30) Foreign Application Priority Data
Nov. 17, 2020 (JP) 2020-191040

(51) Int. Cl. H01M 10/0565

(52) U.S. Cl. CPC H01M 10/0565; H01M 2300/0082; H01M 2300/0085

(57) ABSTRACT

A solid electrolyte of the present disclosure includes: a polymer compound including at least one selected from the group consisting of a structural unit X represented by the following formula (1) and a structural unit Y represented by the following formula (2); and a supporting salt.

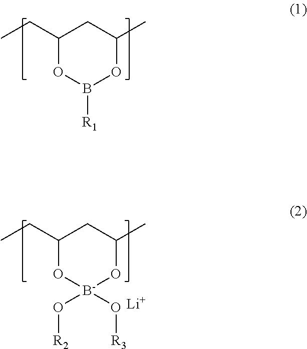

This application is a continuation of PCT/JP2021/035204 filed on Sep. 24, 2021, which claims foreign priority of Japanese Patent Application No. 2020-191040 filed on Nov. 17, 2020, the entire contents of both of which are incorporated herein by reference.

### BACKGROUND OF THE INVENTION

### 1. Field of the Invention

The present disclosure relates to a solid electrolyte, a battery, and a solid electrolyte manufacturing method.

### 2. Description of Related Art

In lithium secondary batteries, on which research and development have been actively conducted in recent years, the electrolyte has a significant influence not only on the battery characteristics, such as the charge and discharge rate, the life characteristics of the charge and discharge cycle, and the conservation characteristics, but also on the safety. A study has been conventionally conducted on an enhancement in battery characteristics by improving the electrolyte.

Electrolytes in liquid form are composed of, for example, a solvent and a supporting salt containing lithium. As used herein, an electrolyte in liquid form is referred to also simply as an electrolyte solution. From the viewpoint of enhancing the energy density of the battery, the solvent widely used for the electrolyte solution is a nonaqueous solvent, which has a potential window larger than water. Note that, however, the electrolyte solution can leak from the battery cell. The electrolyte solution thus has a safety problem. To solve this problem to enhance the safety of the battery, the research on solid electrolytes has been advanced.

In particular, solid electrolytes containing a polymer compound can be formed in the shape of a film and can be reduced in film thickness. For this reason, such solid electrolytes are expected to enhance the efficiency in incorporation into electronic apparatuses and to enhance the design flexibility in electronic devices.

### SUMMARY OF THE INVENTION

In conventional arts, solid electrolytes containing a polymer compound have been required to have an enhanced ionic conductivity.

A solid electrolyte of the present disclosure includes:
a polymer compound including at least one selected from the group consisting of a structural unit X represented by the following formula (1) and a structural unit Y represented by the following formula (2); and
a supporting salt

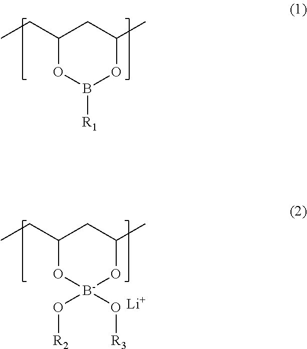

in the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group, and
in the formula (2), R₂ and R₃ are each independently a hydrogen atom, an optionally substituted hydrocarbon group having 1 to 6 carbon atoms, an acyl group, an alkoxycarbonyl group, an amide group, or a cyano group, and R₂ and R₃ are optionally bonded to each other to form a ring structure.

According to the present disclosure, it is possible to enhance the ionic conductivity of a solid electrolyte containing a polymer compound.

### BRIEF DESCRIPTION OF THE DRAWINGS

FIG. 1 is a cross-sectional view schematically showing the configuration of a battery according to an embodiment of the present disclosure.

FIG. 2 is a graph showing the results of an impedance measurement performed on each of a test cell including a solid electrolyte of Comparative Example 1 and a test cell including a solid electrolyte of Example 3.

### DETAILED DESCRIPTION

(Findings on which the Present Disclosure is Based)

Reports have been conventionally made on an electrolyte in which a polymer compound is mixed with a liquid component such as a solvent or an ionic liquid (for example, JP 2012-234673 A, JP H10-334945 A, and Y. S. Zhu et al., “A new single-ion polymer electrolyte based on polyvinyl alcohol for lithium ion batteries”, Electrochimica Acta, 2013, Vol. 87, pp. 113-118.). In this electrolyte, the liquid component functions as the plasticizer or the carrier for ions. Owing to the mixing of a polymer compound with a liquid component, the resultant electrolyte tends to be enhanced in ionic conductivity. However, as in the electrolyte solution, the liquid component contained in the electrolyte can leak from the battery cell.

With respect to a polymer compound contained in an electrolyte, a study has been conducted on an introduction of a boron atom having an empty p orbital for the purpose of enhancing the ion transport number and increasing the ion oxidation potential. A polymer compound into which a boron atom is introduced also has an advantage of being less prone to an electrochemical oxidation. For example, as the material of an electrolyte, a polymer compound containing a boron atom is disclosed in JP 2012-234673 A and Y. S. Zhu et al., “A new single-ion polymer electrolyte based on polyvinyl alcohol for lithium ion batteries”, Electrochimica Acta, 2013, Vol. 87, pp. 113-118.

However, as described above, the polymer compound is mixed with the liquid component in JP 2012-234673 A and Y. S. Zhu et al., “A new single-ion polymer electrolyte based on polyvinyl alcohol for lithium ion batteries”, Electrochimica Acta, 2013, Vol. 87, pp. 113-118. For example, in JP 2012-234673 A, the ionic conductivity is measured for electrolytes containing a polymer compound and a large amount of ionic liquid (Experimental Examples 1 to 6). In Y. S. Zhu et al., “A new single-ion polymer electrolyte based on polyvinyl alcohol for lithium ion batteries”, Electrochimica Acta, 2013, Vol. 87, pp. 113-118., the ionic conductivity is measured for an electrolyte obtained by immersing a polymer compound in propylene carbonate. It has been conventionally considered difficult to enhance the ionic conductivity of a polymer compound without mixing with a liquid component.

As a result of intensive studies, the present inventor has newly found that a combination of a specific polymer compound and a supporting salt can enhance the ionic conductivity of an electrolyte with almost no need for a liquid component.

(Overview of One Aspect According to the Present Disclosure)

A solid electrolyte according to a first aspect of the present disclosure includes:
a polymer compound including at least one selected from the group consisting of a structural unit X represented by the following formula (1) and a structural unit Y represented by the following formula (2); and
a supporting salt

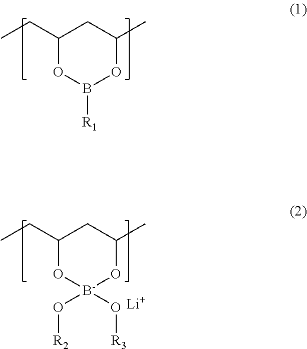

in the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group, and
in the formula (2), R₂ and R₃ are each independently a hydrogen atom, an optionally substituted hydrocarbon group having 1 to 6 carbon atoms, an acyl group, an alkoxycarbonyl group, an amide group, or a cyano group, and R₂ and R₃ are optionally bonded to each other to form a ring structure.

According to the first aspect, in the structural unit X of the polymer compound, the boron atom has an empty p orbital. Via this p orbital, anions contained in the supporting salt can coordinate to the boron atom. This sufficiently dissociates cations contained in the supporting salt. Owing to the dissociated cations, the ionic conductivity of the solid electrolyte can be easily enhanced. Further, the structural unit Y can easily increase the concentration of the cations derived from the supporting salt in the solid electrolyte. Owing to the increase in concentration of the cations, the ionic conductivity of the solid electrolyte can be easily enhanced.

In a second aspect of the present disclosure, for example, in the solid electrolyte according to the first aspect, the supporting salt may include lithium bis(fluorosulfonyl)imide. Such a configuration tends to be able to further enhance the ionic conductivity of the solid electrolyte owing to a high dissociability of lithium bis(fluorosulfonyl)imide.

In a third aspect of the present disclosure, for example, in the solid electrolyte according to the first or second aspect, the structural unit X may be represented by the following formula (3)

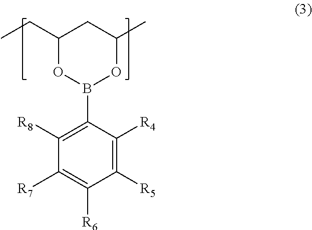

in the formula (3), R₄ to R₈ are each independently a hydrogen atom, an optionally substituted hydrocarbon group having 1 to 6 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group.

The above configuration tends to be able to further enhance the ionic conductivity of the solid electrolyte.

In a fourth aspect of the present disclosure, for example, in the solid electrolyte according to the third aspect, at least one selected from the group consisting of the R₄ to the R₈ may be a hydroxyl group, an acyl group, an acyloxy group, an alkoxycarbonyl group, a carbonate group, an amide group, a carbamate group, or an alkoxy group. According to such a configuration, a substituent containing an oxygen atom is introduced into the phenyl group bonded to the boron atom. This substituent tends to be able to further enhance the ionic conductivity of the solid electrolyte.

In a fifth aspect of the present disclosure, for example, in the solid electrolyte according to the first or second aspect, the structural unit X may be represented by the following formula (4)

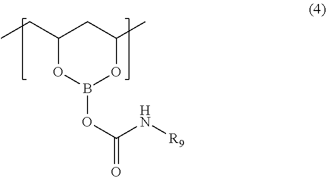

in the formula (4), R₉ is a hydrogen atom, an optionally substituted hydrocarbon group having 1 to 6 carbon atoms, an acyl group, an alkoxycarbonyl group, an amide group, or a cyano group.

The above configuration tends to be able to further enhance the ionic conductivity of the solid electrolyte.

In a sixth aspect of the present disclosure, for example, in the solid electrolyte according to any one of the first to fifth aspects, the structural unit Y may be represented by the following formula (5).

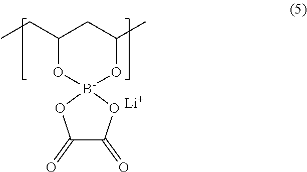

The above configuration tends to be able to further enhance the ionic conductivity of the solid electrolyte.

In a seventh aspect of the present disclosure, for example, in the solid electrolyte according to any one of the first to sixth aspects, a ratio of the number of moles of the supporting salt to a sum of the total number of moles of the structural unit X and the total number of moles of the structural unit Y may be 0.5 or more and 2 or less. Such a configuration tends to be able to further enhance the ionic conductivity of the solid electrolyte.

A battery according to an eighth aspect of the present disclosure includes:
a positive electrode;
a negative electrode; and
an electrolyte layer, wherein
at least one selected from the group consisting of the positive electrode, the negative electrode, and the electrolyte layer includes the solid electrolyte according to any one of the first to seventh aspects.

According to the above configuration, since the battery contains the solid electrolyte, there is almost no leakage of the liquid component from the battery, and therefore the battery is highly safe. The battery containing the solid electrolyte of the present aspect also tends to have favorable output characteristics.

A solid electrolyte manufacturing method according to a ninth aspect of the present disclosure includes
removing, from a liquid mixture including: a polymer compound; a supporting salt; and a solvent, the solvent, where the polymer compound includes at least one selected from the group consisting of a structural unit X represented by the following formula (1) and a structural unit Y represented by the following formula (2)

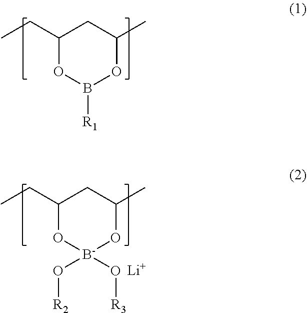

in the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group, and
in the formula (2), R₂ and R₃ are each independently a hydrogen atom, an optionally substituted hydrocarbon group having 1 to 6 carbon atoms, an acyl group, an alkoxycarbonyl group, an amide group, or a cyano group, and R₂ and R₃ are optionally bonded to each other to form a ring structure.

According to the above configuration, it is possible to obtain a solid electrolyte having an enhanced ionic conductivity.

An embodiment of the present disclosure will be described below with reference to the drawings.

(Solid Electrolyte)

A solid electrolyte of the present embodiment contains a polymer compound P and a supporting salt. As used herein, a solid electrolyte refers to an electrolyte that is substantially free of a liquid component. The content of the liquid component in the solid electrolyte is, for example, 0.1 wt % or less, and may be 0.01 wt % or less. In other words, the solid electrolyte consists substantially of a solid component. As used herein, a liquid component refers to a component that is liquid at ordinary temperature, and a solid component refers to a component that is solid at ordinary temperature. The ordinary temperature refers to 20° C. Specific examples of the liquid component include a nonaqueous solvent and an ionic liquid.

The polymer compound P contains at least one selected from the group consisting of a structural unit X represented by the following formula (1) and a structural unit Y represented by the following formula (2).

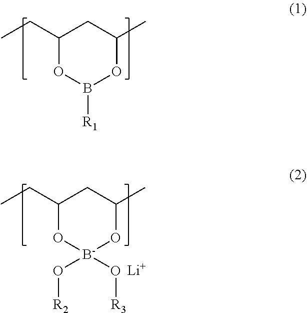

First, the structural unit X will be described. In the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group.

The hydrocarbon group as R₁ may have 18 or less, 12 or less, or 6 or less carbon atoms. The hydrocarbon group may have 2 or more carbon atoms. The hydrocarbon group may be linear, branched, or cyclic. Examples of the hydrocarbon group include a chained saturated hydrocarbon group, a chained unsaturated hydrocarbon group, a cyclic saturated hydrocarbon group, a cyclic unsaturated hydrocarbon group, and a combination thereof.

Examples of the chained saturated hydrocarbon group include a methyl group, an ethyl group, a propyl group, a butyl group, a pentyl group, and a hexyl group. Examples of the cyclic saturated hydrocarbon group include a cyclopentyl group and a cyclohexyl group.

The chained unsaturated hydrocarbon group and the cyclic unsaturated hydrocarbon group include an unsaturated bond such as a carbon-carbon double bond or a carbon-carbon triple bond. Examples of the chained unsaturated hydrocarbon group include a vinyl group and an ethynyl group. Examples of the cyclic unsaturated hydrocarbon group include a phenyl group.

The hydrocarbon group may be substituted or unsubstituted. Examples of the substituent of the hydrocarbon group include a hydroxyl group, an acyl group, an acyloxy group, an alkoxycarbonyl group, a carbonate group, an amide group, a carbamate group, an alkoxy group, a cyano group, a bromo group, a fluoro group, a chloro group, and an iodine group. The hydrocarbon group may have a substituent containing an oxygen atom such as a hydroxyl group, an acyl group, an acyloxy group, an alkoxycarbonyl group, a carbonate group, an amide group, a carbamate group, and an alkoxy group. In the substituent containing an oxygen atom, an interaction can occur between the oxygen atom and cations derived from the supporting salt. This interaction tends to be able to further enhance the ionic conductivity of the solid electrolyte.

The acyl group is represented by, for example, —CORₐ. The acyloxy group is represented by, for example, —OCOR_{b}. The alkoxycarbonyl group is represented by, for example, —COOR_{c}. The carbonate group is represented by, for example, —OCOOR_{d}. The amide group is represented by, for example, —CONRₑR_{f}. The carbamate group is represented by, for example, —OCONR_{g}Rₕ. The alkoxy group is represented by, for example, —ORᵢ.

The above Rₐ to Rᵢ are each independently a hydrocarbon group having 1 to 6 carbon atoms. Examples of this hydrocarbon group include those described above. The hydrocarbon group as each of Rₐ to Rᵢ may be a chained saturated hydrocarbon group. The hydrocarbon group as each of Rₐ to Rᵢ may have 4 or less carbon atoms. The fewer carbon atoms the hydrocarbon group as each of Rₐ to Rᵢ has, the more the ionic conductivity of the solid electrolyte tends to be enhanced. The hydrocarbon group as each of Rₐ to Rᵢ may further have the substituent described above. Rₑ and R_{f} of the amide group and R_{g} and Rₕ of the carbamate group each may be independently a hydrogen atom.

The structural unit X may be represented by the following formula (3).

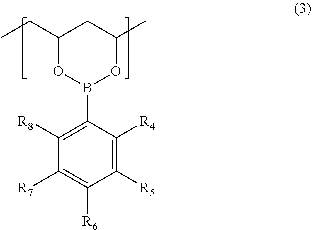

In the formula (3), R₄ to R₈ are each independently a hydrogen atom, an optionally substituted hydrocarbon group having 1 to 6 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group. Examples of these substituents include those described above for R₁.

At least one selected from the group consisting of R₄ to R₈ may be a hydroxyl group, an acyl group, an acyloxy group, an alkoxycarbonyl group, a carbonate group, an amide group, a carbamate group, or an alkoxy group, may be an alkoxycarbonyl group or an alkoxy group, or may be an alkoxy group. A specific example of the alkoxycarbonyl group as each of R₄ to R₈ is a methoxycarbonyl group. A specific example of the alkoxy group as each of R₄ to R₈ is a methoxy group. The structural unit X, which has the structure in which the substituent containing an oxygen atom is introduced into the phenyl group, tends to be able to further enhance the ionic conductivity of the solid electrolyte.

In the formula (3), one or more or two or more substituents may be introduced into the phenyl group. In the case where a plurality of substituents are introduced into the phenyl group, the plurality of substituents may be adjacent to each other. In an example, in the formula (3), both R₄ and R₅ each may be a substituent containing an oxygen atom. In the formula (3), both R₅ and R₆ each may be a substituent containing an oxygen atom.

The structural unit X may be represented by the following formula (4).

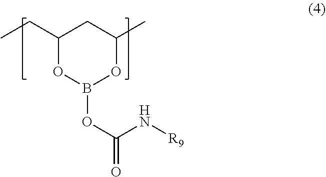

In the formula (4), R₉ is a hydrogen atom, an optionally substituted hydrocarbon group having 1 to 6 carbon atoms, an acyl group, an alkoxycarbonyl group, an amide group, or a cyano group. Examples of these substituents include those described above for R₁.

R₉ is, for example, a substituted hydrocarbon group having 1 to 6 carbon atoms. In an example, R₉ may be represented by the following formula (6).

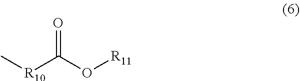

In the formula (6), R₁₀ is a divalent hydrocarbon group having 1 to 6 carbon atoms. Examples of the divalent hydrocarbon group include a methylene group, an ethylene group, a propane-i1,3-diyl group, a butane-1,4-diyl group, a pentane-1,5-diyl group, and a hexane-1,6-diyl group. R₁₀ may be a methylene group or a propane-1,3-diyl group. The hydrocarbon group as R₁₀ may further have the substituent described above for R₁. A specific example of the substituent of the hydrocarbon group as R₁₀ is an alkoxycarbonyl group. In an example, R₁₀ may be 1-ethoxycarbonylpropane-1,3-diyl group.

R₁₁ is a hydrocarbon group having 1 to 6 carbon atoms. Examples of this hydrocarbon group include those described above for R₁. Specific examples of R₁₁ include an ethyl group and a butyl group.

Next, the structural unit Y will be described. In the formula (2), R₂ and R₃ are each independently a hydrogen atom, an optionally substituted hydrocarbon group having 1 to 6 carbon atoms, an acyl group, an alkoxycarbonyl group, an amide group, or a cyano group. Examples of these substituents include those described above for R₁.

R₂ and R₃ are optionally bonded to each other to form a ring structure. The structural unit Y may be represented by, for example, the following formula (5).

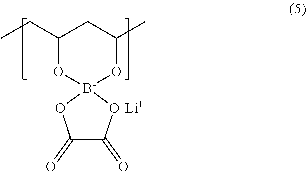

In the present embodiment, the polymer compound P may contain, of the structural units X and Y, only the structural unit X or only the structural unit Y. The content of the structural unit X in the polymer compound P may be 30 mol % or more, 50 mol % or more, 70 mol % or more, or 90 mol % or more. The polymer compound P consists substantially of the structural unit X, for example.

The content of the structural unit Y in the polymer compound P may be 30 mol % or more, 50 mol % or more, 70 mol % or more, or 90 mol % or more. The polymer compound P consists substantially of the structural unit Y, for example.

The sum of the content of the structural unit X and the content of the structural unit Y in the polymer compound P may be 30 mol % or more, 50 mol % or more, 70 mol % or more, or 90 mol % or more. The polymer compound P consists substantially of the structural units X and Y, for example.

The degree of polymerization of the polymer compound P is not particularly limited as long as it is more than 0, and may be 10 or more, 50 or more, 100 or more, 500 or more, or 1000 or more. The upper limit for the degree of polymerization of the polymer compound P is, for example, 10000.

The supporting salt contained in the solid electrolyte is, for example, a lithium salt that is solid at ordinary temperature. Examples of the lithium salt that can be used as the supporting salt include lithium bis(fluorosulfonyl)imide(LiN(FSO₂)₂), LiPF₆, LiBF₄, LiAsF₆, LiCF₃SO₃, LiN(CF₃SO₂)₂, LiC(CF₃SO₂)₃, LiSbF₆, LiSiF₆, LiAIF₄, LiSCN, LiCIO₄, LiCl, LiF, LiBr, Lil, and LiAICI₄. The supporting salt may contain at least one selected from the group consisting of LiN(FSO₂)₂, LiPF₆, LiBF₄, LiAsF₆, LiCF₃SO₃, and LiN(CF₃SO₂)₂, or may contain LiN(FSO₂)₂. Owing to having a high dissociability, LiN(FSO₂)₂ tends to be able to easily enhance the ionic conductivity of the solid electrolyte when combined with the polymer compound P.

In the solid electrolyte of the present embodiment, the ratio between the polymer compound P and the supporting salt is not particularly limited. In an example, a ratio R of the number of moles of the supporting salt to the sum of the total number of moles of the structural unit X and the total number of moles of the structural unit Y is 0.5 or more and 2 or less. The total number of moles of the structural unit X means the total of the number of moles of the structural unit X in all the polymer compounds P contained in the solid electrolyte. The total number of moles of the structural unit Y means the total of the number of moles of the structural unit Y in all the polymer compounds P contained in the solid electrolyte. The ratio R may be 0.75 or more or 1 or more. The higher the ratio R is, the more the ionic conductivity of the solid electrolyte tends to be enhanced.

The sum of the content of the polymer compound P and the content of the supporting salt in the solid electrolyte is, for example, 90 wt % or more, and may be 95 wt % or more, 97 wt % or more, or 99 wt % or more. The solid electrolyte consists substantially of the polymer compound P and the supporting salt, for example.

The solid electrolyte is not limited to a particular shape, and is, for example, in the shape of a film.

The solid electrolyte of the present embodiment can be produced by, for example, the following method. First, a polymer compound P is synthesized. The method of synthesizing the polymer compound P is not particularly limited, and a known method can be used.

For example, the polymer compound P containing the structural unit X can be synthesized by the following method. First, a polymer compound P1 containing a structural unit Z1 represented by the following formula (7) is prepared. A specific example of the polymer compound P1 is a polyvinyl alcohol.

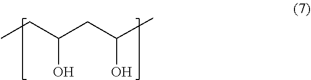

Next, a solution containing the polymer compound P1 is produced. The solvent for this solution is not particularly limited, and an organic solvent such as dimethyl sulfoxide can be used, for example. Next, to this solution, a boron compound C1 represented by the following formula (8) is added. In the formula (8), R₁ is the same as in the formula (1).

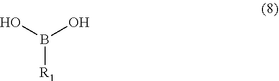

Next, the polymer compound P1 and the boron compound C1 are reacted with each other in the solution. The reaction between the polymer compound P1 and the boron compound C1 may be performed by a heat treatment of the solution. The temperature for the heat treatment is, for example, 60° C. or higher. The time for the heat treatment is, for example, 1 hour or longer. Through the reaction between the polymer compound P1 and the boron compound C1, the polymer compound P containing the structural unit X can be synthesized.

The method of synthesizing the polymer compound P containing the structural unit X is not limited to the method described above. For example, in the case where the structural unit X is represented by the formula (4), the polymer compound P can also be synthesized by the following method. First, instead of the boron compound C1, boric acid (B(OH)₃) is reacted with the above polymer compound P1. Thus, a polymer compound P2 containing a structural unit Z2 represented by the following formula (9) is obtained.

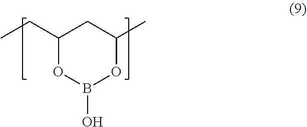

Next, an isocyanate compound C2 represented by the following formula (10) is added to the solution. In the formula (10), R₉ is the same as in the formula (4).

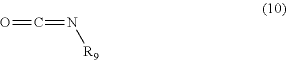

Next, the polymer compound P2 and the isocyanate compound C2 are reacted with each other in the solution. The reaction between the polymer compound P2 and the isocyanate compound C2 may be performed by a heat treatment of the solution. The temperature for the heat treatment is, for example, 60° C. or higher. The time for the heat treatment is, for example, 1 hour or longer. Through the reaction between the polymer compound P2 and the isocyanate compound C2, the polymer compound P containing the structural unit X represented by the formula (4) can be synthesized.

The polymer compound P containing the structural unit Y represented by the formula (5) can be synthesized by, for example, the following method. First, the polymer compound P2 containing the structural unit Z2 represented by the formula (9) is synthesized by the method described above. Next, oxalic acid and a lithium salt are added to a solution containing the polymer compound P2. The lithium salt that can be used is, for example, lithium carbonate. The polymer compound P2 and oxalic acid are reacted with each other in the presence of the lithium salt. The reaction between the polymer compound P2 and oxalic acid may be performed by a heat treatment of the solution. The temperature for the heat treatment is, for example, 80° C. or higher. The time for the heat treatment is, for example, 10 hours or longer. Through the reaction between the polymer compound P2 and oxalic acid, the polymer compound P containing the structural unit Y represented by the formula (5) can be synthesized.

Next, a liquid mixture including the polymer compound P, the supporting salt, and a solvent is produced. The solvent for the liquid mixture may be the same as or different from the solvent used in the synthesis of the polymer compound P. For example, in the case where the polymer compound P is synthesized by the method described above, a solution containing the polymer compound P is obtained. To this solution, the supporting salt may be added to produce the liquid mixture.

Next, the solvent is removed from the liquid mixture. Thus, the solid electrolyte can be produced. That is, the solid electrolyte manufacturing method of the present embodiment includes removing the solvent from the liquid mixture, which includes the polymer compound P, the supporting salt, and the solvent. The method for removing the solvent from the liquid mixture is not particularly limited. For example, the solvent may be removed by applying the liquid mixture onto a substrate and heat-treating the resultant coating. The substrate onto which the liquid mixture is to be applied can be, for example, soda glass. The conditions for the heat treatment of the coating can be appropriately adjusted according to the type of solvent. The temperature for the heat treatment is, for example, 50° C. or higher. The time for the heat treatment is, for example, 5 hours or longer. The heat treatment may be performed in a reduced pressure atmosphere or in a vacuum atmosphere.

The solid electrolyte of the present embodiment contains the polymer compound P and the supporting salt. The structural units X and Y of the polymer compound P each have a structure in which a substituent containing a boron atom is introduced into a polymer compound having a linear alkyl chain as a main chain. In the structural unit X of the polymer compound P, the boron atom has an empty p orbital. Via this p orbital, anions contained in the supporting salt can coordinate to the boron atom. This sufficiently dissociates cations contained in the supporting salt. The cations contained in the supporting salt are typically lithium ions. Owing to the dissociated lithium ions, the ionic conductivity of the solid electrolyte can be easily enhanced.

In the structural unit Y of the polymer compound P, anions are strongly attracted to the polymer compound P. Consequently, the structural unit Y per se can interfere with the transportation of ions. However, the structural unit Y can easily increase the concentration of cations derived from the supporting salt in the solid electrolyte. Owing to the increase in concentration of the cations, the ionic conductivity of the solid electrolyte can be enhanced. In other words, the polymer compound P containing the structural unit Y can easily enhance the ionic conductivity of the solid electrolyte when combined with the supporting salt.

Further, the solid electrolyte of the present embodiment has a high ionic conductivity despite being substantially free of a liquid component such as a solvent or an ionic liquid. The ionic conductivity of the solid electrolyte is not particularly limited, and is, for example, 1.00×10⁻⁷ S/cm or more, and may be 1.00×10⁻⁶ S/cm or more, 1.00×10⁻⁵ S/cm or more, or 1.00×10⁻⁴ S/cm or more. The upper limit for the ionic conductivity of the solid electrolyte is, for example, 1.00×10⁻¹ S/cm.

(Battery)

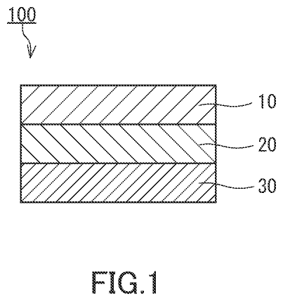

FIG. 1 is a cross-sectional view schematically showing the configuration of a battery 100 according to the present embodiment. As shown in FIG. 1, the battery 100 includes a positive electrode 10, a negative electrode 30, and an electrolyte layer 20. The electrolyte layer 20 is positioned between the positive electrode 10 and the negative electrode 30. At least one selected from the group consisting of the positive electrode 10, the negative electrode 30, and the electrolyte layer 20 contains the solid electrolyte described above.

The battery 100 is, for example, a solid-state battery. Examples of the shape of the battery 100 include a coin type, a cylindrical type, a prismatic type, a sheet type, a button type, a flat type, and a stack type.

The battery 100 of the present embodiment contains the solid electrolyte described above. Accordingly, owing to the solid electrolyte, there is almost no leakage of the liquid component from the battery 100, and therefore the battery 100 is highly safe. The battery 100 also tends to have favorable output characteristics.

### EXAMPLES

The present disclosure will be described below in detail with reference to examples and a comparative example. The present disclosure is not limited to the following examples.

### Comparative Example 1

First, a polyvinyl alcohol (manufactured by Sigma-Aldrich Co., LLC.) was dissolved in dimethyl sulfoxide in an inert atmosphere. The content of the polyvinyl alcohol in the resultant solution was 5 wt %. The polyvinyl alcohol was composed of a structural unit Z derived from vinyl alcohol. The structural unit Z1 represented by the formula (7) described above corresponds to a structural unit in which two structural units Z are arranged.

Next, to the solution, boric acid (manufactured by Tokyo Chemical Industry Co., Ltd.) was added in 0.5 molar equivalents relative to the total number of moles of the structural unit Z. The total number of moles of the structural unit Z means the total of the number of moles of the structural unit Z in all the polyvinyl alcohols contained in the solution. Next, the solution was heated at 80° C. for 5 hours to react the polyvinyl alcohol with boric acid.

Next, oxalic acid (manufactured by Tokyo Chemical Industry Co., Ltd.) and lithium carbonate (manufactured by Tokyo Chemical Industry Co., Ltd.) were added to the solution. The respective addition amounts of oxalic acid and lithium carbonate were each 0.5 molar equivalents relative to the total number of moles of the structural unit Z. Next, the resultant solution was heated at 100° C. for 24 hours. Thus, the polymer compound P containing the structural unit Y represented by the formula (5) described above was synthesized.

Next, the solution was cooled to room temperature. This solution was applied onto soda glass to obtain a coating. This coating was heat-treated at 70° C. for 10 hours, and further heat-treated in a vacuum atmosphere at 70° C. for 48 hours to dry the coating. Thus, a solid electrolyte of Comparative Example 1 was obtained. The solid electrolyte of Comparative Example 1 was in the shape of a film.

### Example 1

A solid electrolyte of Example 1 was obtained by the same method as in Comparative Example 1 except the following performed after the synthesis of the polymer compound P: the addition of lithium bis(fluorosulfonyl)imide (manufactured by Kishida Chemical Co., Ltd.) in 0.25 molar equivalents relative to the total number of moles of the structural unit Z to the solution; and the heating of the resultant solution at 70° C. for 2 hours.

### Example 2

A solid electrolyte of Example 2 was obtained by the same method as in Example 1 except the change in addition amount of lithium bis(fluorosulfonyl)imide to 0.375 molar equivalents relative to the total number of moles of the structural unit Z.

### Example 3

A solid electrolyte of Example 3 was obtained by the same method as in Example 1 except the change in addition amount of lithium bis(fluorosulfonyl)imide to 0.5 molar equivalents relative to the total number of moles of the structural unit Z.

### Example 4

First, a polyvinyl alcohol (manufactured by Aldrich) was dissolved in dimethyl sulfoxide in an inert atmosphere. The content of the polyvinyl alcohol in the resultant solution was 5 wt %. Next, to the solution, ethylboronic acid (manufactured by Tokyo Chemical Industry Co., Ltd.) was added in 0.5 molar equivalents relative to the total number of moles of the structural unit Z. Next, the solution was heated at 80° C. for 10 hours to react the polyvinyl alcohol with ethylboronic acid. Thus, the polymer compound P containing the structural unit X represented by the formula (1) described above was synthesized.

Next, to the solution, lithium bis(fluorosulfonyl)imide (manufactured by Kishida Chemical Co., Ltd.) was added in 0.5 molar equivalents relative to the total number of moles of the structural unit Z. The resultant solution was heated at 70° C. for 2 hours. Next, the solution was applied onto soda glass to obtain a coating. This coating was heat-treated at 70° C. for 10 hours, and further heat-treated in a vacuum atmosphere at 70° C. for 48 hours for drying. Thus, a solid electrolyte of Example 4 was obtained. The solid electrolyte of Example 4 was in the shape of a film.

### Example 5

A solid electrolyte of Example 5 was obtained by the same method as in Example 4 except the use of 3-(methoxycarbonyl)phenylboronic acid (manufactured by Tokyo Chemical Industry Co., Ltd.) instead of ethylboronic acid.

### Example 6

A solid electrolyte of Example 6 was obtained by the same method as in Example 4 except the use of 3,4-dimethoxyphenylboronic acid (manufactured by Tokyo Chemical Industry Co., Ltd.) instead of ethylboronic acid.

### Example 7

A solid electrolyte of Example 7 was obtained in the same manner as in Example 4 except the use of 2,3-dimethoxyphenylboronic acid (manufactured by Tokyo Chemical Industry Co., Ltd.) instead of ethylboronic acid.

### Example 8

First, a polyvinyl alcohol (manufactured by Sigma-Aldrich Co., LLC.) was dissolved in dimethyl sulfoxide in an inert atmosphere. The content of the polyvinyl alcohol in the resultant solution was 5 wt %. Next, to the solution, boric acid (manufactured by Tokyo Chemical Industry Co., Ltd.) was added in 0.5 molar equivalents relative to the total number of moles of the structural unit Z. Next, the solution was heated at 80° C. for 5 hours to react the polyvinyl alcohol with boric acid.

Next, to the solution, butyl isocyanatoacetate (manufactured by Tokyo Chemical Industry Co., Ltd.) was added in 0.5 molar equivalents relative to the total number of moles of the structural unit Z. Next, the resultant solution was heated at 80° C. for 10 hours. Thus, the polymer compound P containing the structural unit X represented by the formula (4) described above was synthesized.

Next, to the solution, lithium bis(fluorosulfonyl)imide (manufactured by Kishida Chemical Co., Ltd.) was added in 0.5 molar equivalents relative to the total number of moles of the structural unit Z. The resultant solution was heated at 70° C. for 2 hours. Next, the solution was applied onto soda glass to obtain a coating. This coating was heat-treated at 70° C. for 10 hours, and further heat-treated in a vacuum atmosphere at 70° C. for 48 hours for drying. Thus, a solid electrolyte of Example 8 was obtained. The solid electrolyte of Example 8 was in the shape of a film.

### Example 9

A solid electrolyte of Example 9 was obtained by the same method as in Example 8 except the use of diethyl (S)-(−)-2-isocyanatoglutarate (manufactured by Tokyo Chemical Industry Co., Ltd.) instead of butyl isocyanatoacetate.

[Measurement of Ionic Conductivity]

The ionic conductivity was measured for the solid electrolytes of the examples and the comparative example by the following method. First, the solid electrolyte was punched into a disc shape having a diameter of 9 mm. This solid electrolyte was sandwiched between a working electrode and a counter electrode, and thus a Swagelok cell was assembled. The working electrode and the counter electrode used were each a Ni plate. An impedance measurement was performed on the obtained test cell at room temperature with VSP-300 (manufactured by Bio-Logic SAS). At this time, the frequency range was adjusted to 0.1 MHz or more and 7 MHz or less.

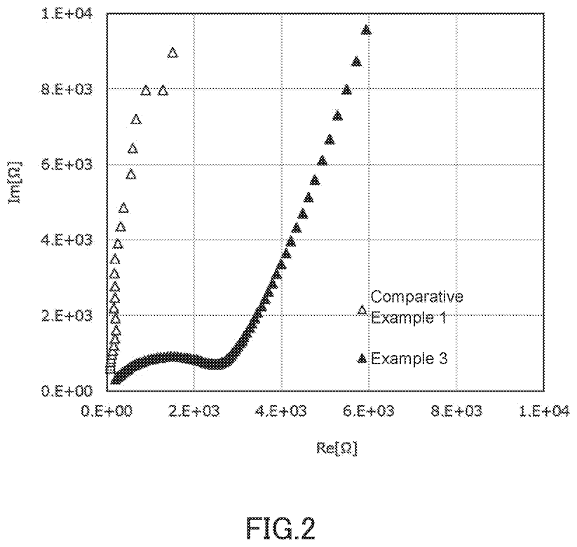

FIG. 2 is a graph showing the results of the impedance measurement performed on each of the test cell including the solid electrolyte of Comparative Example 1 and the test cell including the solid electrolyte of Example 3. As can be seen from FIG. 2, no circular arc appeared on the graph in Comparative Example 1, unlike in Example 3.

Next, on the basis of the results of the impedance measurement, the ionic conductivity was specified for the solid electrolytes of the examples and the comparative example. The results are shown in Table 1.

TABLE 1

| | Structural | | | |
|---|---|---|---|---|
| | unit of | | | Ionic |
| | polymer | Supporting | | conductivity |
| | compound | electrolyte | Molar ratio between materials of solid electrolyte | [S/cm] |
| Comparative | Y1 | — | Polyvinyl alcohol (the total number of moles of structural unit Z):boric | N.A. |
| Example 1 | | | acid:lithium carbonate:oxalic acid = | (Measurement |
| | | | 1:0.5:0.5:0.5 | failure |
| | | | | due to high |
| | | | | resistance) |
| Example 1 | Y1 | LiN(FSO₂)₂ | Polyvinyl alcohol (the total number of moles of structural unit Z):boric | 7.91 × 10⁻⁷ |
| | | | acid:lithium carbonate:oxalic acid:lithium bis(fluorosulfonyl)imide = | |
| | | | 1:0.5:0.5:0.5:0.25 | |
| Example 2 | Y1 | LiN(FSO₂)₂ | Polyvinyl alcohol (the total number of moles of structural unit Z):boric | 1.18 × 10⁻⁵ |
| | | | acid:lithium carbonate:oxalic acid:lithium bis(fluorosulfonyl)imide = | |
| | | | 1:0.5:0.5:0.5:0.375 | |
| Example 3 | Y1 | LiN(FSO₂)₂ | Polyvinyl alcohol (the total number of moles of structural unit Z):boric | 8.95 × 10⁻⁵ |
| | | | acid:lithium carbonate:oxalic acid:lithium bis(fluorosulfonyl(imide = | |
| | | | 1:0.5:0.5:0.5:0.5 | |
| Example 4 | X1 | LiN(FSO₂)₂ | Polyvinyl alcohol (the total number of moles of structural unit Z):ethylboronic | 7.56 × 10⁻⁵ |
| | | | acid:lithium bis(fluorosulfonyl)imide = | |
| | | | 1:0.5:0.5 | |
| Example 5 | X2 | LiN(FSO₂)₂ | Polyvinyl alcohol (the total number of moles of structural unit Z):3-(meth- | 1.89 × 10⁻⁶ |
| | | | oxycarbonyl)phenylboronic acid:lithium bis(fluorosulfonyl)imide = | |
| | | | 1:0.5:0.5 | |
| Example 6 | X3 | LiN(FSO₂)₂ | Polyvinyl alcohol (the total number of moles of structural unit Z):3,4- | 3.80 × 10⁻⁴ |
| | | | dimethoxyphenylboronic acid:lithium bis(fluorosulfonyl)imide = | |
| | | | 1:0.5:0.5 | |
| Example 7 | X4 | LiN(FSO₂)₂ | Polyvinyl alcohol (the total number of moles of structural unit Z):2,3- | 9.08 × 10⁻⁴ |
| | | | dimethoxyphenylboronic acid:lithium bis(fluorosulfonyl)imide = | |
| | | | 1:0.5:0.5 | |
| Example 8 | X5 | LiN(FSO₂)₂ | Polyvinyl alcohol (the total number of moles of structural unit Z):boric acid:butyl | 5.81 × 10⁻⁴ |
| | | | isocyanatoacetate:lithium bis(fluorosulfonyl)imide = | |
| | | | 1:0.5:0.5:0.5 | |
| Example 9 | X6 | LiN(FSO₂)₂ | Polyvinyl alcohol (the total number of moles of structural unit Z):boric acid:di- | 2.83 × 10⁻⁴ |
| | | | ethyl (S)-(−)-2-isocyanatoglutarate:lithium bis(fluorosulfonyl)imide = | |
| | | | 1:0.5:0.5:0.5 | |

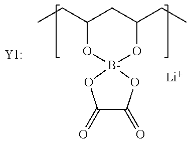

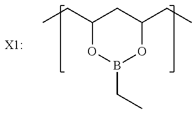

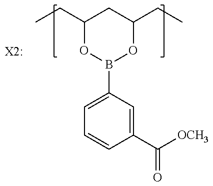

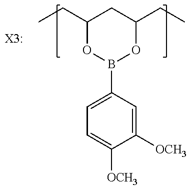

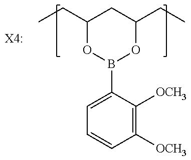

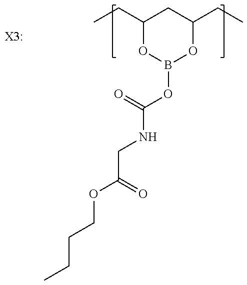

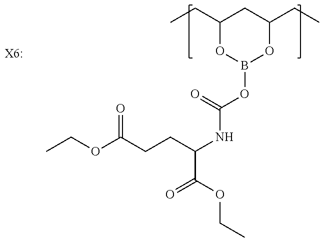

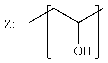

As can be seen from Table 1, the solid electrolyte containing the polymer compound P and the supporting salt had a sufficiently high ionic conductivity as the ion conductor despite being substantially free of a liquid component such as a solvent or an ionic liquid. Further, as can be seen from the results of Examples 1 to 3, the higher the concentration of the supporting salt in the solid electrolyte was, the more the ionic conductivity of the solid electrolyte was enhanced. That is, it is inferred that the increase in concentration of the supporting salt increased the concentration of the carrier in the solid electrolyte.

### INDUSTRIAL APPLICABILITY

The solid electrolyte of the present disclosure can be, for example, used for lithium secondary batteries and the like.

What is claimed is:

1. A solid electrolyte comprising:
a polymer compound including at least one selected from the group consisting of a structural unit X represented by the following formula (1) and a structural unit Y represented by the following formula (2); and
a supporting salt 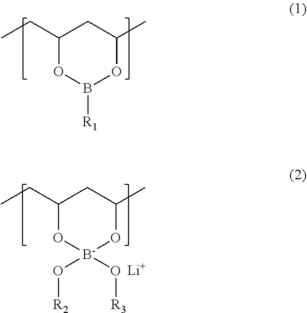
in the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group, and
in the formula (2), R₂ and R₃ are each independently a hydrogen atom, an optionally substituted hydrocarbon group having 1 to 6 carbon atoms, an acyl group, an alkoxycarbonyl group, an amide group, or a cyano group, and R₂ and R₃ are optionally bonded to each other to form a ring structure.

2. The solid electrolyte according to claim 1, wherein
the supporting salt includes lithium bis(fluorosulfonyl)imide.

3. The solid electrolyte according to claim 1, wherein
the structural unit X is represented by the following formula (3) 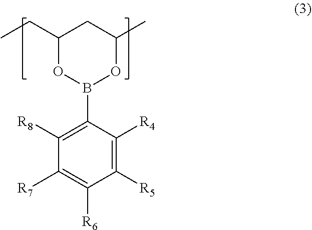
in the formula (3), R₄ to R₈ are each independently a hydrogen atom, an optionally substituted hydrocarbon group having 1 to 6 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group.

4. The solid electrolyte according to claim 3, wherein
at least one selected from the group consisting of the R₄ to the R₈ is a hydroxyl group, an acyl group, an acyloxy group, an alkoxycarbonyl group, a carbonate group, an amide group, a carbamate group, or an alkoxy group.

5. The solid electrolyte according to claim 1, wherein
the structural unit X is represented by the following formula (4) 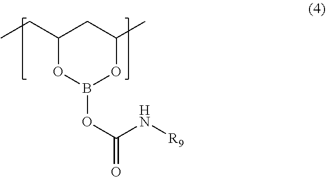
in the formula (4), R₉ is a hydrogen atom, an optionally substituted hydrocarbon group having 1 to 6 carbon atoms, an acyl group, an alkoxycarbonyl group, an amide group, or a cyano group.

6. The solid electrolyte according to claim 1, wherein
the structural unit Y is represented by the following formula (5)

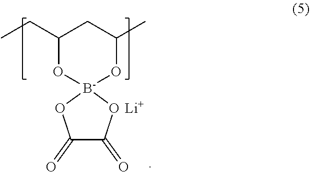

7. The solid electrolyte according to claim 1, wherein
a ratio of the number of moles of the supporting salt to a sum of the total number of moles of the structural unit X and the total number of moles of the structural unit Y is 0.5 or more and 2 or less.

8. A battery comprising:
a positive electrode;
a negative electrode; and
an electrolyte layer, wherein
at least one selected from the group consisting of the positive electrode, the negative electrode, and the electrolyte layer includes the solid electrolyte according to claim 1.

9. A solid electrolyte manufacturing method comprising:
removing, from a liquid mixture including: a polymer compound; a supporting salt; and a solvent, the solvent, where the polymer compound includes at least one selected from the group consisting of a structural unit X represented by the following formula (1) and a structural unit Y represented by the following formula (2) 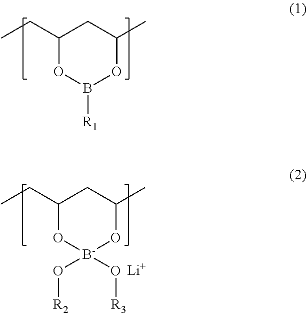
in the formula (1), R₁ is a hydrogen atom, an optionally substituted hydrocarbon group having 1 to 36 carbon atoms, a hydroxyl group, an acyl group, an acyloxy group, an alkoxycarbonyl group, a carbonate group, an amide group, a carbamate group, an alkoxy group, a cyano group, a bromo group, a fluoro group, a chloro group, or an iodine group, and
in the formula (2), R₂ and R₃ are each independently a hydrogen atom, an optionally substituted hydrocarbon group having 1 to 6 carbon atoms, an acyl group, an alkoxycarbonyl group, an amide group, or a cyano group, and R₂ and R₃ are optionally bonded to each other to form a ring structure.
